(19) United States
(12) Patent Application Publication
(10) Pub. No.: US 2006/0084432 A1
(43) Pub. Date: Apr. 20, 2006

(54) Differentiated access parameters for random access channel

(75) Inventors: Srinivasan Balasubramanian, San Diego, CA (US); Thawatt Gopal, San Diego, CA (US)

Correspondence Address: COATS & BENNETT, PLLC, P O BOX 5, RALEIGH, NC, 27602, US

(73) Assignee: Telefonaktiebolaget LM Ericsson (publ)

(21) Appl. No.: 11/252,153

(22) Filed: Oct. 17, 2005

Related U.S. Application Data
(60) Provisional application No. 60/619,781, filed on Oct. 18, 2004.

(51) Int. Cl. H04Q 7/20

(52) U.S. Cl. 455/434; 455/445

(57) ABSTRACT

Two or more different sets of access parameters are stored in mobile station memory. When the mobile station sends an access message on the reverse access channel, it selects a set of access parameters based on the type of service. For high priority services, the mobile station selects a set of access parameters that reduces call setup latency. The network can change a selected set of access parameters by sending an access parameter message containing the updated parameter values. The access parameter message includes a priority field indicating the selected set of access parameters to be updated.

### RELATED APPLICATIONS

This application claims the benefit of U.S. Provisional Patent Application 60/619,781 filed Oct. 18, 2004, which is incorporated herein by reference.

### BACKGROUND

The present invention relates generally to random access channels for mobile communication networks and, more particularly, to a random access channel that permits differentiated access for different types of services.

The reverse access channel (R-ACH) and reverse enhanced access channel (R-EACH) are contention-based random access channels used by mobile stations to send uplink signaling messages to a base station when no traffic channel has been allocated to the mobile station. The access channel can be used by the mobile station to register with a network, to originate a call, or to respond to a paging message. An access channel message consists of a preamble and a message capsule that contains a Layer 2 encapsulated packet data unit (PDU) plus some padding bits so that the message capsule ends at a frame boundary. The preamble does not carry any message, but is transmitted to help the base station capture the phase and timing of the mobile station's transmissions on the uplink. Once the preamble is detected, the base station can demodulate the message capsule and process the mobile station's request.

The process of sending one Layer 2 encapsulated PDU from the mobile station to the base station is referred to as an access attempt. An access attempt comprises a predetermined number of access probe sequences. During each access probe sequence, the mobile station transmits a series of access probes, each one increasing in strength, until a response is received. If a response is not received, the access probe is repeated a predetermined number of times. The number of access probe sequences, the number of access probes within an access probe sequence, the back off time between access probe sequences, the back off time between access probes within a sequence, the power step between access probes within a sequence, and persistence are examples of access parameter settings that can be configured to control the access channel. The parameters controlling the access channel are contained in the Access Parameters Message (APM) sent on the forward paging channel (F-PCH).

Currently, the access parameter settings apply to all service options. However, there is no one single set of access parameter settings that is ideal for all service options. Settings for best effort applications may produce unacceptable results for delay intolerant services, such as voice-over IP and push-to-talk applications. A compromise solution would be to find an acceptable trade-off between settings optimized for best effort applications and settings optimized for delay intolerant applications. The ability to use a different set of access parameter settings for different service options would allow the access parameters to be optimized for each service option and improve overall system performance.

### SUMMARY

The present invention enables the use of differentiated access parameters for different types or categories of services in a mobile communication network. Different services may be divided into two or more service groups. Each service group may have a defined set of access parameters that is different from the other service groups. For example, services that are not tolerant of delay, such as voice-over-IP and push-to-talk services, may use a first defined set of access parameters that reduce call setup latency. Services that require only best effort service may use a second defined set of access parameters. When an application makes a request for access to the network, the mobile station determines the service group to which the application belongs and selects the appropriate set of access parameters for the service group. The mobile station then sends an access message to the network on the reverse access channel using the selected set of access parameters.

The network notifies the mobile station of the access parameters for each service group. To differentiate between the access parameters for different service groups, the access parameter message is modified to include a group ID field. The group ID field may contain one or more bits indicating the group to which the included access parameters apply. Upon receipt of the access parameter message, the mobile stations update and/or store the access parameters in memory.

### BRIEF DESCRIPTION OF THE DRAWINGS

FIG. 1 illustrates an exemplary mobile communication network.

FIG. 2 illustrates an exemplary mobile station.

FIG. 3 illustrates the operating states of the mobile station.

FIG. 4 illustrates an exemplary structure of a reverse access channel for a mobile communication network.

FIG. 5 illustrates an exemplary access channel signaling procedure.

FIG. 6 illustrates an exemplary format for an access parameter message used to set access parameters for the reverse access channel.

FIG. 7 illustrates an exemplary procedure implemented by a mobile station for sending access messages on a reverse access channel.

FIG. 8 illustrates an exemplary procedure implemented by a base station for sending access parameter messages.

### DETAILED DESCRIPTION

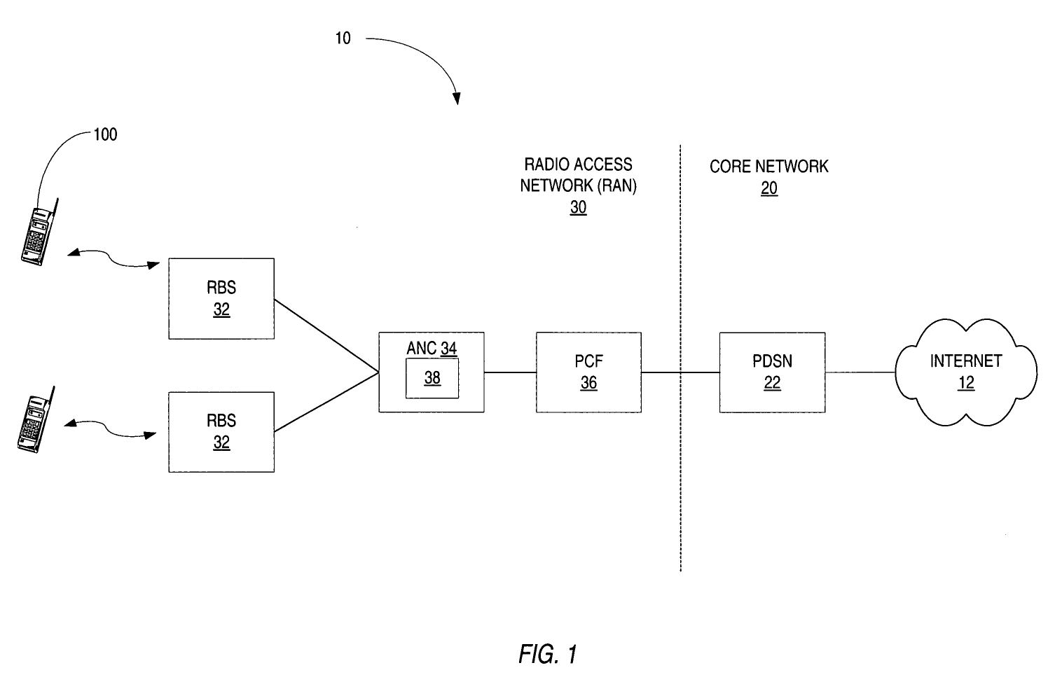

FIG. 1 illustrates an exemplary mobile communication network indicated generally by the numeral 10. The network 10 may be configured according to any known network standard including without limitation the IS2000, IS-856, Wideband CDMA, GPRS/EDGE and WiMax standards The exemplary embodiment shown in FIG. 1 is configured according to the IS-2000 standard, also known as cdma2000. Mobile communication network 10 comprises a packet-swtiched core network 20 and one or more radio access networks (RANs) 30.

The core network 20 includes a Packet Data Serving Node (PDSN) 22. The PDSN 22 connects to an external packet data network (PDN) 12, such as the Internet, and supports PPP connections to and from the mobile station 100. The PDSN 22 adds and removes IP streams to and from the RANs 30 and routes packets between the external packet data network 12 and the RANs 30.

The RANs 30 provide the connection between the mobile stations 100 and the core network 20. The RANs 30 comprises a plurality of radio base stations (RBSs) 32, at least one access network controller (ANC) 34, and Packet Control Function (PCF) 36. The RBSs 32 include the radio equipment for communicating over the air interface with mobile stations 100. The ANC 34 comprises a control circuit 38 that control operation of the RBSs 32. The ANC 34 manages radio resources for the RBSs 32 in their respective coverage areas and handles Layer 3 signaling. The control circuit 38 may comprise one or more processors, microcontrollers, firmware, or a combination thereof. The PCF 36 is essentially a router that establishes, maintains, and terminates connections from the AN 30 to the PDSN 22. While shown as separate network elements in FIG. 1, those skilled in the art will appreciate that the functions of the RBS 32, ANC 34 and PCF 36 can be integrated into one network element.

In cdma2000 networks, an RBS 32 and an ANC 34 comprise a base station. The RBS 32 is the part of the base station that includes the radio equipment and is normally associated with a cell site. The ANC 34 is the control part of the base station. In cdma2000 networks, a single ANC 34 may comprise the control part of multiple base stations. In other network architectures based on other standards, the network components comprising the base station may be different but the overall functionality will be the same or similar.

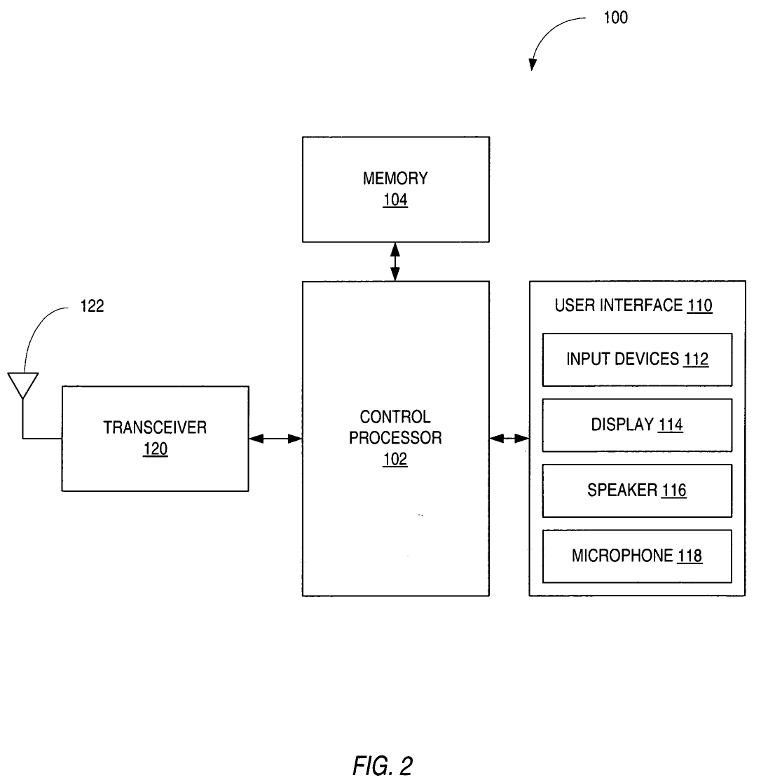

FIG. 2 illustrates an exemplary mobile station 100. Mobile station 100 comprises a control processor 102, memory 104, a user interface 110 and a wireless transceiver 120. Mobile station 100 is capable of both voice and packet data communications.

Control processor 102 controls the overall operation of the mobile station 100 according to programs stored in memory 104. The control functions may be implemented in a single processor, or in multiple processors. Suitable processors may include general purpose microprocessors, microcontrollers, digital signal processors, hardware, firmware, or a combination thereof. Memory 104 represents the entire hierarchy of memory in the mobile station 100, and may include both random access memory (RAM) and read-only memory (ROM). Computer programs and data required for operation are stored in non-volatile memory, such as EPROM, EEPROM, and/or flash memory, which may be implemented as discrete devices, stacked devices, or may be integrated with one or more processors.

The user interface 110 includes one or more user input devices 112, a display 114, a speaker 116, and a microphone 118. The user interface 110 enables a user to interact with and control the mobile station 100. The user input devices 112 may comprise any known computer input devices, such as keypads, touch pads, joystick controls, scroll wheels, and buttons, that allow a user to input data and commands. A voice recognition system or touch screen display screen display may also be used for user input. Display 114 may comprise a liquid crystal display (LCD) to enable the user to view menus and other information. Speaker 116 converts analog audio signals into audible signals that can be heard by the user. Microphone 118 converts the detected speech and other audible signals into electrical audio signals for input to the control processor 102.

Transceiver 120 is coupled to antenna 122 for receiving and transmitting signals. Transceiver 120 is a fully functional cellular radio transceiver, which may operate according to any known standard, including the standards known generally as the Global System for Mobile Communications (GSM), TIA/EIA-136, cdmaOne, cdma2000, UMTS, and Wideband CDMA.

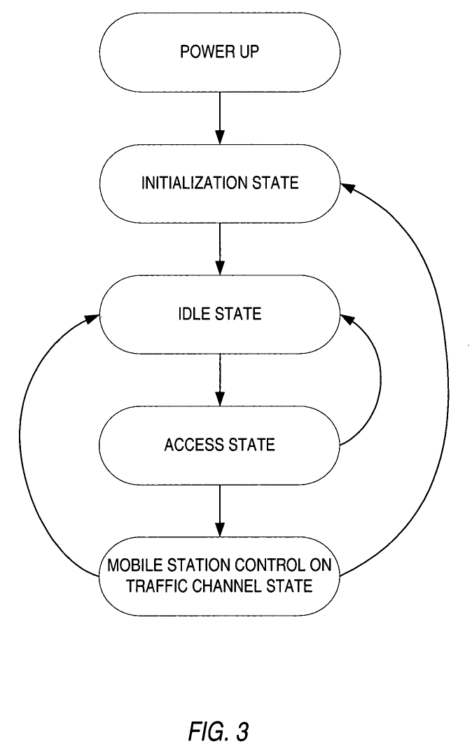

FIG. 3 illustrates the operating states of the mobile station 100. The operating states include the initialization state, the idle state, the access state, and the mobile station control on the traffic channel state (referred to as the traffic state for short). The mobile station 100 enters the initialization state after the mobile station 100 powers up. In the initialization state, the mobile station 100 selects which system to use, acquires the forward pilot channel (F-PICH), obtains system configuration and timing information from the forward synchronization channel (F-SYNCH), and synchronizes its timing to the network 10. After synchronizing, the mobile station 100 enters the idle state. In the idle state, the mobile station 100 is not assigned a traffic channel. The mobile station 100 monitors forward broadcast and control channels including the forward paging channel (F-PCH) and forward common control channel (F-CCCH). If the mobile station 100 needs to access the network, the mobile station 100 transitions from the idle state to the access state. For example, the mobile station 100 may need to perform a registration, to originate a call, or to respond to a paging. In the access state, the mobile station 100 sends messages to the RBS 32 on the reverse access channel (R-ACH) or reverse enhanced access channel (R-EACH). If the system access is to perform a registration, the mobiles station returns to the idle state after its registration message is acknowledged. If the purpose of the access is to set-up a traffic channel, the mobile station 100 will be assigned a traffic channel and enter the traffic state. In the traffic state, the mobile station 100 and RBS 32 communicate using the forward and reverse traffic channels.

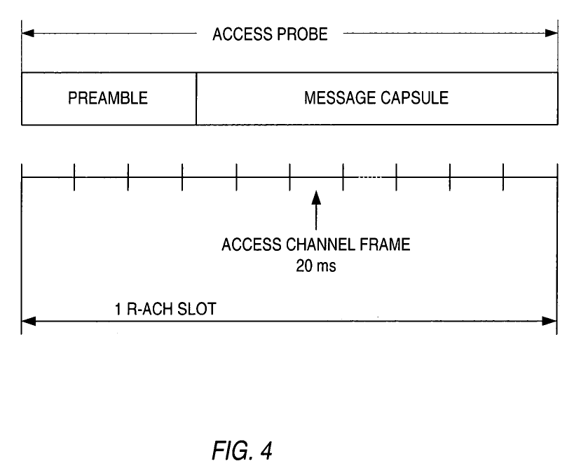

FIG. 4 illustrates the structure of the R-ACH. The R-ACH is a contention-based access channel for sending Layer 2 signaling messages, referred to herein as access messages, when the mobile station 100 is not assigned a traffic channel. The R-ACH is divided into time slots. Each time slot comprises 4 to 26 frames of 20 ms duration. Individual access messages are contained in short bursts of data called access probes. The access probe is synchronized with the start of an R-ACH time slot with a small pseudorandom delay in the range of 0 to 511 chips to help avoid collisions. An access probe comprises a preamble and a message capsule. The message capsule is 80 ms in duration. The preamble comprises an all “0” sequence and is transmitted to help the RBS 32 capture the phase and timing of the mobile station's transmission. The message capsule carries the message data. Once the preamble is detected, the RBS 32 can coherently decode and process the message data.

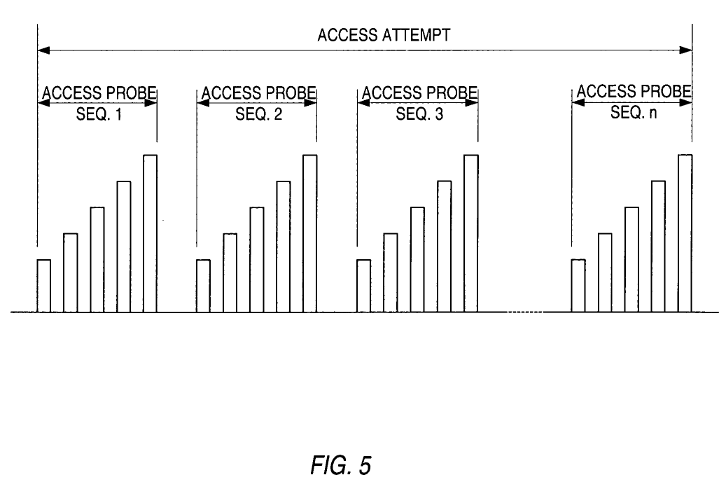

FIG. 5 illustrates an exemplary access attempt. An access attempt comprises a series of access probes. During an access attempt, the mobile station 100 sends one or more access probes. After each access probe, the mobile station 100 waits for a response from the RBS 32. The wait time or backoff before the next access probe is pseudo-randomly selected. The access probes are grouped into access probe sequences. Within an access probe sequence, each successive access probe increases in strength, and the access probe sequence is repeated a predetermined number of times until the access attempt is acknowledged by the RBS 32. The mobile station 100 may, in some cases, be required to perform persistence testing between access probe sequences. The purpose of persistence testing is to reduce collision of the access channel. If persistence testing is used, the mobile station 100 performs a series of persistence trials or tests and does not start the next access probe sequence until either the persistence test is passed or until a predetermined number of trials are performed. The number of trials may be pseudo-randomly selected to randomize the time between probe sequences.

The network 10 may send access parameters to the mobile station 100 on the F-PCH to control operation on the R-ACH and/or R-EACH. Access parameters are used to control variables such as the number of access probe sequences within an access attempt, the number of access probes within an access probe sequence, the backoff between access probes and access probe sequences, the power step between access probes within an access probe sequence, and persistence testing. These access control parameters are transmitted to the mobile station 100 in an access parameters message on the F-PCH.

In determining the access parameter settings, there is a tradeoff between interference, call setup latency, and the probability of success. For example, the value for the initial power and power step increments may be increased to improve the likelihood of success at the expense of greater interference. On the other hand, reducing the initial power and power step increment may increase the average number of access probes needed for a successful attempt, which increases the call setup latency and interference due to the unsuccessful attempts. For some services, call setup latency may not be a concern, so settings that reduce interference may be desirable. For some services, such a voice-over-IP (VoIP) and push-to-talk (PTT), reducing call set up latency is important and settings that reduce the time to successfully access the network may be desirable. Currently, there is no mechanism to provide differentiated access parameter settings, so some compromise solution is typically used.

According to the present invention, different access parameters can be assigned to different types or classifications of services. For example, the IS-2000 standard has defined Service Options 60 and 61 for VoIP services, which require low call setup latency. A network operator could, according to the present invention, create a first set of access parameter settings to reduce call setup latency for VoIP services. A second set of access parameters could be defined for applications that require only best effort service. Additional sets of access parameters could be defined for other services.

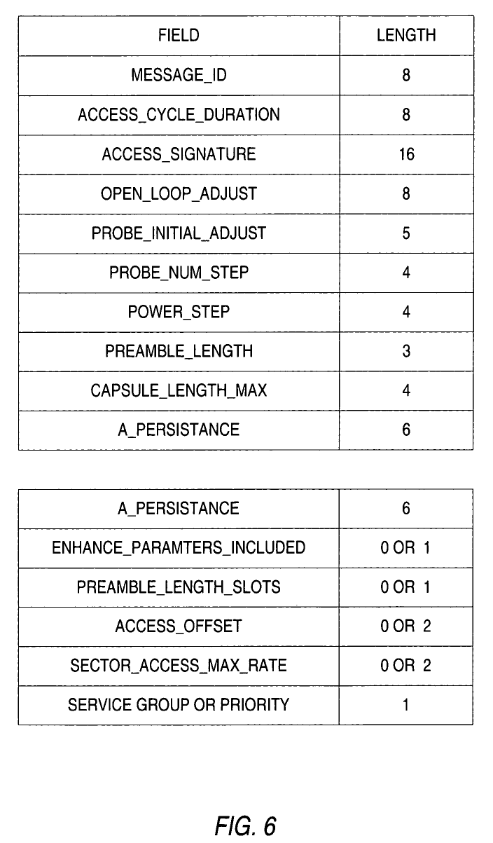

The access parameters for accessing the network are determined by the ANC 34. At any given time, the ANC 34 may define one or more service groups with different access parameter settings. The ANC 34 notifies the mobile stations 100 of the access parameter settings by sending an Access Parameter Message (APM). For each service group, the ANC 34 sends an APM with the corresponding access parameter settings on the F-PCH. FIG. 6 illustrates an exemplary APM. The APM includes a service group field or priority field that is used to indicate a particular set of access parameters. The value of the service group indicates to which service group the access parameters belong. In one embodiment, two service categories are defined: high priority and low priority. The high priority set of access parameters is typically used for high priority services, such as VoIP or push-to-talk, where immediate access and low call setup latency are requirements. The low priority access parameters are typically used for best effort services. The service group field or priority field in this case could comprises a single bit set to “1” to indicate high priority, and set to “0” to indicate low priority. A two-bit service group or priority field would enable the network to discriminate between four different service categories. More generally, the service group field allows the mobile stations 100 to discriminate between 2ⁿ sets of access channels parameters, where n is the number of bits in the service group field of the APM.

By modifying the APM to include a service group field, it is possible to discriminate between different sets of access parameters for different services. Network operators can for example set different access persistence factors and different power step values for high priority services so that when a mobile station 100 originates a call, it has a higher probability of connecting and shorter call setup latency. The mobile station 100 stores each set of access parameters in its memory 104. Each application would be assigned a service group or priority that indicates which set of access parameters it should use. Thus, the access parameters can be tailored for the requirements of the specific service. The number of service groups or priority levels can be determined by the network operator and may be fixed.

To prevent abuse, the conditions under which the high priority access parameters can be used may be specified in applicable standards, and mobile stations can be tested for compliance with the standards. For example, the standard may require that mobile stations use the high priority access parameters only when the associated services are invoked.

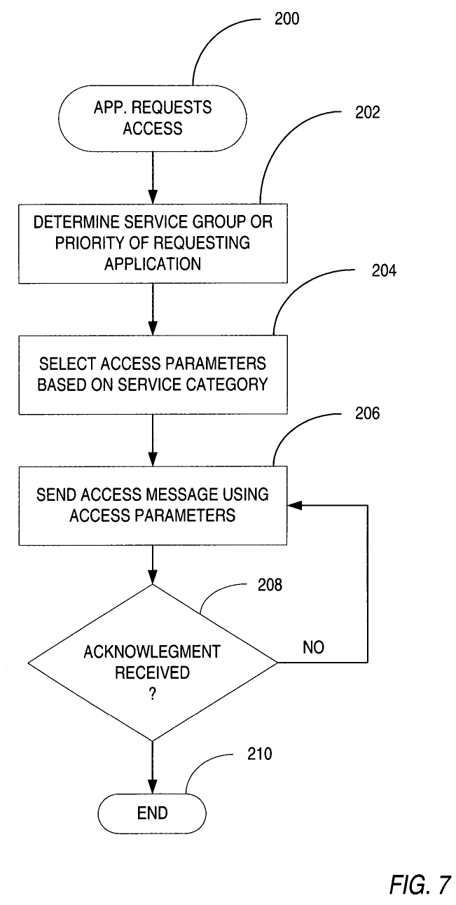

FIG. 7 illustrates exemplary processing performed by the mobile station 100 to send an access message to the network 10 on the R-ACH. When an application requests access to the network 10 and no traffic channel is assigned (block 200), the mobile station 100 determines the service group or priority of the application making the request (block 202) and selects the access parameters based on the service group (block 204). The mobile station 100 then sends an access message to the network using the corresponding access parameters (block 206) and waits for and acknowledgment from the network (block 208). The procedure ends (block 210) when the acknowledgement is received.

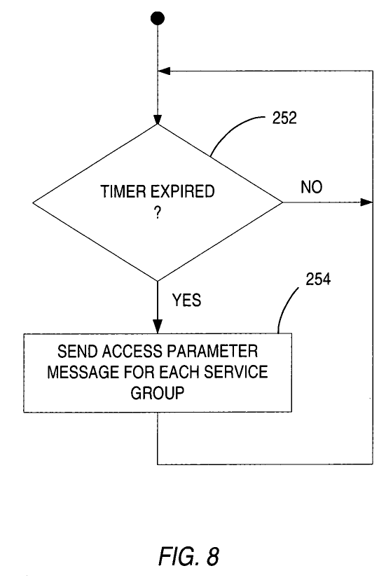

FIG. 8 illustrates a procedure implemented by the ANC 34 for sending periodic access parameters to the mobile station 100. The ANC 34 may send an APM periodically at a predetermined time interval, or whenever conditions require that the access parameters be changed. Conditions requiring a change in the access parameters include congestion of the reverse access channel. When the timer expires (block 252), or when conditions dictate, the ANC 34 sends an APM to the mobile station 100 (block 254) including the corresponding access parameters for the service group. The service group is indicated by the service group field as previously described. Based on the service group field, the mobile station 100 is able to determine what access parameter set the APM applies to.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method implemented by a mobile station for accessing a communication network, said method comprising:
storing at least two sets of access parameters in memory;
selecting a set of access parameters based on service type; and
sending a message from said mobile station to said communication network on an access channel using said selected access parameters.

2. The method of claim 1 wherein said sets of access parameters includes a high priority set of access parameters for services and a low priority set of access parameters.

3. The method of claim 2 further comprising classifying selected services as high priority services and wherein selecting a set of access parameters comprises selecting said high priority set of access parameters for said high priority services.

4. The method of claim 3 wherein selecting a set of access parameters comprises selecting said low priority set of access parameters for services not classified as high priority services.

5. The method of claim 3 wherein said high priority services includes voice-over-IP and push-to-talk services.

6. The method of claim 1 further comprising updating a selected set of access parameters based on parameter values received from said communication network in an access parameter message.

7. The method of claim 6 wherein said access parameter message includes a service group field indicating the selected set of access parameters.

8. A mobile station comprising:
a transceiver for communicating with a communication network;
a memory for storing two or more sets of access parameters; and
a control unit for controlling operation of said transceiver, said control unit operative to:
select a set of access parameters based on a type of service; and
send an access message to said communication network via said transceiver using the selected set of access parameters.

9. The mobile station of claim 8 wherein said sets of access parameters includes a high priority set of access parameters for services and a low priority set of access parameters.

10. The mobile station of claim 9 wherein said control unit is configured to classify selected services as high priority services and to select said high priority set of access parameters for said high priority services.

11. The mobile station of claim 10 wherein said control unit is configured to select said low priority set of access parameters for services not classified as high priority services.

12. The mobile station of claim 10 wherein said high priority services includes voice-over-IP and push-to-talk services.

13. The mobile station of claim 8 wherein said control unit is further operative to update a selected set of access parameters based on parameter values received from said communication network in an access parameter message.

14. The mobile station of claim 13 wherein said access parameter message includes a service group field indicating the selected set of access parameters.

15. A method of updating access parameters used by a mobile station to send access messages on a reverse access channel, said method comprising:
sending an access parameter message containing updated parameter values for a selected set of access parameters from a base station to said mobile station; and
including a priority indication in said access parameter message to indicate the selected set of access parameters to be updated.

16. A network controller for controlling a radio base station in a mobile communication network comprising:
a control circuit including at least one processor operative to:
send an access parameter message to said mobile stations to update a selected set of access parameters; and
include in said access parameter message, a priority indication to indicate the selected set of access parameters to be updated.
